(19) United States
(12) Patent Application Publication
(10) Pub. No.: US 2024/0384033 A1
(43) Pub. Date: Nov. 21, 2024

(54) FURAN DIACID-BASED POLYAMIDE, PREPARATION METHOD THEREFOR, AND FURAN DIACID-BASED POLYAMIDE COMPOSITION

(71) Applicants: ZHUHAI VANTEQUE SPECIALTY ENGINEERING PLASTICS CO., LTD., Guangdong (CN); KINGFA SCI. & TECH. CO., LTD., Guangdong (CN)

(72) Inventors: Kun YAN, Guangdong (CN); Xianjun XU, Guangdong (CN); Sujun JIANG, Guangdong (CN); Min CAO, Guangdong (CN); Jiehong MAI, Guangdong (CN); Huixin YANG, Guangdong (CN); Zhiqiang JIANG, Guangdong (CN)

(73) Assignees: ZHUHAI VANTEQUE SPECIALTY ENGINEERING PLASTICS CO., LTD., Guangdong (CN); KINGFA SCI. & TECH. CO., LTD., Guangdong (CN)

(21) Appl. No.: 18/692,835

(22) PCT Filed: Sep. 15, 2022
(86) PCT No.: PCT/CN2022/118965

§ 371 Date: Mar. 18, 2024

(30) Foreign Application Priority Data
Sep. 24, 2021 (CN) 202111122743.2

(51) Int. Cl. C08G 69/26; C08G 69/28; C08K 5/52; C08K 5/5313; C08K 7/14

(52) U.S. Cl. CPC C08G 69/265; C08G 69/28; C08K 5/5205; C08K 5/5313; C08K 7/14

(57) ABSTRACT

The present invention discloses a furan diacid-based polyamide, which is derived from the following repeating units: (A) 2,5-furandicarboxylic acid, (B) 1,4-cyclohexanedicarboxylic acid, and (C) 1,5-pentanediamine, where based on the total molar percentage of the diacid units, (A) accounts for 10-45 mol % of the diacid units. The furan diacid-based polyamide of the present invention has a melting point of 291-335° C.

### TECHNICAL FIELD

The present invention relates to the technical field of high polymer materials, and in particular to a furan diacid-based polyamide and a furan diacid-based polyamide composition.

### DESCRIPTION OF RELATED ART

Traditional polyamide monomers are mainly derived from petroleum oil. Nowadays, people are being faced with the problems of excessive petroleum resource consumption, soared carbon dioxide emissions and aggravated greenhouse effect. The decrease of the petroleum-based monomer's consumption can inhibit the carbon dioxide emissions to prevent greenhouse effect, solve the problems of environmental pollution and resource shortage, thereby building a sustainable-development society. Bio-based high-temperature resistant polyamides refer to polyamides obtained from the polymerization of bio-based aliphatic diamines or bio-based arylcyclodiacids. The bio-based monomers are generally extracted from animals and plants, which, on the one hand, can achieve green and sustainable development, on the other hand, can diversify high-temperature resistant polyamide products, thus satisfying the demands of the more subdivisional industries.

Through market survey and analysis, the bio-based monomers decanediamine, pentanediamine and furandicarboxylic acid are regarded as the bio-based high-temperature resistant polyamide monomer materials which are most likely to achieve a substantive breakthrough. Decanediamine is derived from plant castor oil and has achieved mass production at home; but due to its higher price, the market competitiveness is weak. Pentanediamine is derived from glutamic acid fermentation and has achieved mass production at home; and the market competitiveness is good because of its lower price. Furandicarboxylic acid is the only one known bio-based arylcyclodiacid monomer which is most likely to achieve industrialization currently. The domestic and overseas studies on furandicarboxylic acid are being in the trial development stage at present.

Chinese patent application CN106536187A discloses a furan-based polyamide; the bio-based monomer 2,5-furandicarboxylic acid is used and the diamine is aliphatic diamine, aromatic diamine, etc.; the furan-based polyamide has good gas barrier properties. However, the gas barrier properties are mainly achieved by polymerizing a short carbon chain diamine (1,3 propane diamine) to increase the amido bond density. In contrast, such furan polyamide has poor flame retardance.

### SUMMARY

The object of the present invention is to provide a furan diacid-based polyamide which has the advantages of good flame retardance, high melting point, bio-based environmental protection, and low water absorption rate.

Another object of the present invention is to provide a composition containing the aforesaid furan diacid-based polyamide.

The present invention is achieved by the following technical solution.

A furan diacid-based polyamide is derived from the following repeating units: (A) 2,5-furandicarboxylic acid, (B) 1,4-cyclohexanedicarboxylic acid, and (C) 1,5-pentanediamine, wherein based on a total molar percentage of the diacid units, (A) accounts for 10-45 mol % of the diacid units.

Preferably, based on a total molar percentage of the diacid units, (A) accounts for 10-30 mol % of the diacid units.

More preferably, based on a total molar percentage of the diacid units, (A) accounts for 10-15 mol % of the diacid units.

The melting point and water absorption rate are higher at a preferable content of the (A) in the diacid units.

The furan diacid-based polyamide has a relative viscosity of 1.8-2.4.

The furan diacid-based polyamide has a melting point of 291-335° C.

The furan diacid-based polyamide has water absorption rate of less than or equal to 3.3%.

Reaction materials (diamine and diacids) are added to a pressure reactor provided with magnetic coupling stirring, a condenser tube, a gas phase port, a feeding port, and a pressure explosion-proof port: benzoic acid, sodium hypophosphite (catalyst) and deionized water are added; the amount of benzoic acid is 2-3% of a total weight of diamine and diacid, the amount of sodium hypophosphite is 0.05-0.15% of a weight of other materials other than deionized water, and the amount of deionized water is 25-35% of a weight of the total materials; the pressure reactor is vacuumized and pumped with high-purity nitrogen as a shielding gas, and the materials are heated up to 210-230° C. within 2 h under stirring conditions, and then a reaction mixture is stirred for 0.5-2 h at 210-230° C. The reactants are heated up to 220-240° C. under stirring conditions, the reaction proceeds for 1-3 h at a constant temperature of 220-240° C. and a constant pressure of 2.1-2.3 MPa; the pressure is kept constant by removing water formed; a prepolymer is discharged after finishing the reaction and vacuum dried at 70-90° C. to obtain a prepolymerized product, and the prepolymerized product is subjected to solid phase viscosification for 8-12 h at 240-260° C. and a vacuum condition of 40-60 Pa, to obtain the furan diacid-based polyamide.

A furan diacid-based polyamide composition includes the following components in parts by weight:
40-70 parts of the aforesaid furan diacid-based polyamide;
10-30 parts of a halogen-free flame retardant; and
0-50 parts of a reinforcing material.

The halogen-free flame retardant is selected from at least one of the group consisting of a phosphine flame retardant, a hypophosphorous acid ester flame retardant, a hypophosphorous acid salt flame retardant, a phosphinate ester flame retardant, a phosphinate salt flame retardant, a phosphite ester flame retardant, a phosphite salt flame retardant, a phosphine oxide flame retardant, a hypophosphite ester flame retardant, a hypophosphite salt flame retardant, a phosphonate ester flame retardant, a phosphonate salt flame retardant, a phosphate ester flame retardant, and a polyphosphate flame retardant.

The hypophosphite salt flame retardant is selected from at least one of the group consisting of aluminum hypophosphite, calcium hypophosphite, aluminum dimethylhypophosphite, aluminum diethylhypophosphite, and aluminum methylethylhypophosphite; the phosphate ester flame retardant is selected from at least one of the group consisting of bisphenol A bis(diphenyl phosphate), phenoxyphosphonitrile, resorcinol (diphenyl phosphate), triphenyl phosphate, melamine polyphosphate ester and melamine cyanurate; the polyphosphate flame retardant is selected from at least one of the group consisting of ammonium polyphosphate, melamine phosphate, melamine pyrophosphate and melamine polyphosphate salt.

The reinforcing material is selected from at least one of the group consisting of a fibrous filler and a nonfibrous filler; the fibrous filler is selected from at least one of the group consisting of a glass fiber, a carbon fiber, a basalt fiber, a bamboo fiber, fibrilia, a cellulosic fiber and an aramid fiber; the nonfibrous filler is selected from at least one of the group consisting of aluminium oxide, carbon black, clay, zirconium phosphate, kaolin, calcium carbonate, copper powder, kieselguhr, graphite, mica, silica, titanium dioxide, zeolite, talc, wollastonite, glass beads and glass powder.

The polyamide molding composition of the present invention may be used for preparing various types of electronic connector devices in needs of surface mount technology (SMT) such as USB, TYPE-C, and DDR, and widely applied in the fields such as electrical, electronic engineering, and automobile.

Compared with the prior art, the present invention has the following beneficial effects.
1. Diacid units in the furan diacid-based polyamide of the present invention all contain rigid rings, of which cyclohexane has a rigidity higher than that of the aromatic ring and may form more hard carburized layers during combustion. Moreover, the polyamide resin of the present invention has a higher amido bond density and thus, may form an excellent synergistic effect with a fire retardant and accordingly has a good flame retardant efficiency.
2. In the present invention, the furan diacid-based polyamide prepared by adjusting the ratio of furandicarboxylic acid to cyclohexanedicarboxylic acid has a melting point of 291-335° C. and thus, has good temperature tolerance and machinability.
3. Even though the furan diacid-based polyamide of the present invention has a high amido bond density (in comparison to PA10T, PA1010, PA6T, PA56, etc.), has a water absorption rate of less than or equal to 3.3%. This is because the monomers furandicarboxylic acid and cyclohexanedicarboxylic acid all contain rigid rings, of which cyclohexane has a rigidity higher than that of the aromatic ring. The polyamide molecular chain of the present invention has a very strong rigidity; the rigid region formed by these rigid molecular chains hinder the diffusion of water molecules in the polyamide resin; therefore, the water absorption rate is smaller and dimensional stability is better.

### DESCRIPTION OF THE EMBODIMENTS

The present invention will be further specified in detail with reference to the detailed examples below. The following examples will help those skilled in the art further understand the present invention, but are not construed as limiting the present invention in any form. It should be indicated that those skilled in the art may further make several deformations and improvements without departing from the inventive concept of the present invention. These all fall within the protection scope of the present invention.

Raw materials used in the present invention are derived from the following:
2,5-furandicarboxylic acid: purity of 98%, purchased from Ningbo Institute of Materials Technology & Engineering, Chinese Academy of Sciences;
1,4-cyclohexanedicarboxylic acid: purity of 98%, purchased from Sigma-Aldrich;
1,6-hexanedioic acid: purity of 98%, purchased from Sigma-Aldrich;
Terephthalic acid: purity of 98%, purchased from Sigma-Aldrich;
1,5-pentanediamine: purity of 98%, purchased from Shanghai Kaisai Chemical Co., Ltd.; 1,6-hexamethylenediamine: purity of 98%, purchased from Sigma-Aldrich;
1,10-decanediamine: purity of 98%, purchased from Wuxi Yinda Nylon Co., Ltd.; Benzoic acid: analytically pure, purchased from Sigma-Aldrich; Sodium hypophosphite: analytically pure, purchased from Sigma-Aldrich;
Halogen-free flame retardant A: aluminum diethylphosphinate, OP1230, phosphorus mass percentage of 23-24%, purchased from Clariant;
Halogen-free flame retardant B: melamine polyphosphate salt, MELAPUR 200-70, nitrogen mass percentage of 42-44%, phosphorus mass percentage of 12-14%, purchased from BASF; and
reinforcing material: glass fiber, ECS11-4.5-560A, mean diameter of 11 μm, purchased from JUSHI, China.

The polyamide resins in the examples and comparative examples were obtained by the same polymerization process below: reaction materials (diamine and diacids) were added to a pressure reactor provided with magnetic coupling stirring, a condenser tube, a gas phase port, a feeding port, and a pressure explosion-proof port according to the proportion in the table; benzoic acid, sodium hypophosphite (catalyst) and deionized water were added; the amount of benzoic acid was 2% of a total weight of diamine and diacid, the amount of sodium hypophosphite was 0.08% of a weight of other materials other than deionized water, and the amount of deionized water was 25% of a weight of the total materials; the pressure reactor was vacuumized and pumped with high-purity nitrogen as a shielding gas, and the materials were heated up to 230° C. within 2 h under stirring conditions, and then a reaction mixture was stirred for 0.5-2 h at 220° C.; reactants was then heated up to 240° C. under stirring conditions; the reaction proceeded for 1-3 h at a constant temperature of 240° C. and a constant pressure of 2.3 MPa; the pressure was kept constant by removing water formed; a prepolymer was discharged after finishing the reaction, and vacuum dried at 70-90° C. to obtain a prepolymerized product, and the prepolymerized product was subjected to solid phase viscosification for 8-12 h at 260° C. and a vacuum condition of 50 Pa, to obtain the furan diacid-based polyamide (or furan diacid-free polyamide).

### Test Method

(1) Test method for the relative viscosity of polyamide resin: referring to GB12006.1-89 Determination of viscosity number of polyamide; the specific test method is as follows: a relative viscosity nr of the polyamide having a concentration of 0.25 g/dl in 98% concentrated sulfuric acid at 25±0.01° C.
(2) Test method for the melting point of polyamide: referring to ASTM D3418-2003, Standard Test Method for Transition Temperatures of Polymers By Differential Scanning calorimetry; the specific test method is as follows: the melting point of a sample was tested by a Perkin Elmer Dimond DSC analysis meter at the atmosphere of nitrogen and a flow rate of 50 mL/min; the sample was first heated up to 350° C. at 20° C./min, and maintained for 2 min at 350° C.; resin thermal history was removed, and then the sample was cooled to 50° C. at 20° C./min and maintained for 2 min at 50° C., again heated up to 350° C. at 20° C./min, and the endothermic peak temperature at this time was set as the melting point Tm.
(3) Water absorption rate of the polyamide: the sample was injected into 20 mm×20 mm×2 mm sample piece with a weight denoted as a0. The sample was then placed into 95° C. water, and 240 h later, its weight was weighed and denoted as a1. Water absorption rate-(a1−a0)/a0*100%.
(4) Flame retardance: referring to the UL94 V-0 test standard, the standard strip-type sample has a length of 125±5 mm, a width of 13.0±0.5 mm and a thickness of 0.8 mm; 5 samples were at least treated for 48 h at 23±2° C. and 50±5%. Flame of a Bunsen burner was aligned at the center of the lower end of the sample; the center of the top surface of the Bunsen burner tube was kept 10±1 mm away from the lower end face of the sample for 10±0.5 S; the Bunsen burner was moved with the change of the length and position of the sample if necessary. Flame was applied to the test sample for 10±0.5 S, and the Bunsen burner was then immediately removed to at least 150 mm away from the test sample at about 300 mm/s. Meanwhile, flame combustion time T1 (unit: s) of the test sample was determined with a timing device. After the flame combustion of the test sample was over, even though the Bunsen burner was not removed to 150 mm away from the test sample, the Bunsen burner was immediately moved and kept 10±1 mm away from the lower end face of the sample, and fame was then applied again for 10±0.5 S; the Bunsen burner was removed to clear away drippings if necessary, and after flame application, the Bunsen burner was immediately removed to at least 150 mm away from the test sample; meanwhile, the timing device was turned on to determine the flame time T2 and flame-free time T3 of the test sample; if T1+T2+T3 of the 5 test samples in average was less than 10 s, and there was no dripping to ignite the lower cotton, it was regarded to meet the V-0 conditions.

TABLE 1
proportions of each monomer of the furan diacid-based polyamide resins in
Examples 1-6 and test results thereof

| | Ex- | Ex- | Ex- | Ex- | Ex- | Ex- | Ex- | Ex- |
|---|---|---|---|---|---|---|---|---|
| | ample | ample | ample | ample | ample | ample | ample | ample |
| | 1 | 2 | 3 | 4 | 5 | 6 | 7 | 8 |
| Resin No. | A | B | C | D | E | F | G | H |
| 2,5-furandicarboxylic | 10 | 15 | 20 | 30 | 40 | 45 | 25 | 25 |
| acid/mol | | | | | | | | |
| 1,4- | 90 | 85 | 80 | 70 | 60 | 55 | 75 | 75 |
| cyclohexanedicarboxylic | | | | | | | | |
| acid/mol | | | | | | | | |
| 1,5-pentanediamine/mol | 100 | 100 | 100 | 100 | 100 | 100 | 100 | 100 |
| Relative viscosity ηr | 2.14 | 2.13 | 2.18 | 2.12 | 2.11 | 2.13 | 1.82 | 2.36 |
| Melting point Tm/° C. | 335 | 328 | 322 | 309 | 298 | 291 | 315 | 315 |
| Water absorption rate/% | 2.2 | 2.3 | 2.4 | 2.8 | 3.1 | 3.3 | 2.6 | 2.6 |

As can be seen from Examples 1-6, the higher the 1,4-cyclohexanedicarboxylic acid is, the higher the melting point is and the lower the water absorption rate is.

Continued table 1: proportions of each monomer of the polyamide
resins in Comparative Examples 1-7 and test results thereof

| | Com- | Com- | Com- | Com- | Com- | Com- | Com- |
|---|---|---|---|---|---|---|---|
| | parative | parative | parative | parative | parative | parative | parative |
| | Ex- | Ex- | Ex- | Ex- | Ex- | Ex- | Ex- |
| | ample | ample | ample | ample | ample | ample | ample |
| | 1 | 2 | 3 | 4 | 5 | 6 | 7 |
| Resin No. | I | J | K | L | M | N | 0 |
| 2,5-furandicarboxylic acid/mol | 5 | 50 | | | 40 | 40 | 40 |
| 1,4-cyclohexanedicarboxylic | 95 | 50 | 60 | | | | 60 |
| acid/mol | | | | | | | |
| 1,6-hexanedioic acid/mol | | | | | 60 | | |
| Terephthalic acid/mol | | | 40 | 100 | | 60 | |
| 1,5-pentanediamine/mol | 100 | 100 | 100 | | 100 | 100 | |
| 1,6- | | | | | | | 100 |
| hexamethylenediamine/mol | | | | | | | |
| 1,10-decanediamine/mol | | | | 100 | | | |
| Relative viscosity ηr | 2.14 | 2.17 | 2.17 | 2.13 | 2.11 | 2.17 | 2.15 |
| Melting point Tm/° C. | 351 | 280 | 307 | 317 | 261 | 282 | 289 |
| Water absorption rate/% | 2.1 | 4.0 | 3.4 | 1.6 | 7.3 | 3.8 | 3.1 |

The furan diacid-based polyamide resin in Comparative Example 1 has a melting point of greater than decomposition temperature and thus, has no use value.

As can be seen from Comparative Example 2, the higher the 2,5-furandicarboxylic acid is, the higher the water absorption rate is, the lower the melting point is, and the use value is low.

As can be seen from Comparative Example 3, when 2,5-furandicarboxylic acid is replaced with terephthalic acid, the water absorption rate may still not reach to 3.3% below.

As can be seen from Comparative Example 5, when cyclohexanedicarboxylic acid is replaced with adipic acid, the amido bond density decreases, while the water absorption rate increases.

As can be seen from Comparative Example 6, when cyclohexanedicarboxylic acid is replaced with terephthalic acid with the similar structure, the water absorption rate is also higher, and the melting point is low.

As can be seen from Comparative Example 7, when 1,5-pentanediamine is replaced with 1,6-hexamethylenediamine, the melting point decreases.

TABLE 3
proportions (part by weight) of each component of the furan diacid-
based polyamide compositions in Examples 9-16 and Comparative
Examples 8-14 and each performance test result thereof

| | Ex- | Ex- | Ex- | Ex- | Ex- | Ex- | Ex- | Ex- |
|---|---|---|---|---|---|---|---|---|
| | ample | ample | ample | ample | ample | ample | ample | ample |
| | 9 | 10 | 11 | 12 | 13 | 14 | 15 | 16 |
| Employed | A | B | C | D | E | F | G | H |
| resin No. | | | | | | | | |
| Resin content | 58 | 58 | 58 | 58 | 58 | 58 | 40 | 70 |
| Halogen-free | 12 | 12 | 12 | 12 | 12 | 12 | 10 | |
| flame retardant | | | | | | | | |
| A | | | | | | | | |
| Halogen-free | | | | | | | | 20 |
| flame retardant | | | | | | | | |
| B | | | | | | | | |
| Reinforcing | 30 | 30 | 30 | 30 | 30 | 30 | 30 | 30 |
| filler | | | | | | | | |
| UL-94 flame | V-0 | V-0 | V-0 | V-0 | V-0 | V-0 | V-0 | V-0 |
| retardant | | | | | | | | |
| rating | | | | | | | | |

As can be seen from Examples 7-12, the furan diacid-based polyamide composition of the present invention has good flame retardance.

Continued table 3:

| | Com- | Com- | Com- | Com- | Com- | Com- | Com- |
|---|---|---|---|---|---|---|---|
| | para- | para- | para- | para- | para- | para- | para- |
| | tive | tive | tive | tive | tive | tive | tive |
| | Ex- | Ex- | Ex- | Ex- | Ex- | Ex- | Ex- |
| | ample | ample | ample | ample | ample | ample | ample |
| | 8 | 9 | 10 | 11 | 12 | 13 | 14 |
| Employed | I | J | K | L | M | N | O |
| resin No. | | | | | | | |
| Resin content | 58 | 58 | 58 | 58 | 58 | 58 | 58 |
| Halogen-free | 12 | 12 | 12 | 12 | 12 | 12 | 12 |
| flame retardant | | | | | | | |
| Reinforcing | 30 | 30 | 30 | 30 | 30 | 30 | 30 |
| filler | | | | | | | |
| UL-94 flame | Fail to | Fail to | V-1 | V-1 | Fail to | V-1 | V-1 |
| retardant rating | mold | mold | | | mold | | |

As can be seen from Comparative Examples 8-9, too high or too low melting point will lead to the failure of processing and molding.

As can be seen from Comparative Examples 10-14, the flame retardance is poor in other diacid/diamine solutions.

1. A furan diacid-based polyamide, derived from following repeating units: (A) 2,5-furandicarboxylic acid, (B) 1,4-cyclohexanedicarboxylic acid, and (C) 1,5-pentanediamine, wherein based on a total molar percentage of diacid units, (A) accounts for 10-45 mol % of the diacid units.

2. The furan diacid-based polyamide according to claim 1, wherein based on the total molar percentage of the diacid units, (A) accounts for 10-30 mol % of the diacid units.

3. The furan diacid-based polyamide according to claim 2, wherein based on the total molar percentage of the diacid units, (A) accounts for 10-15 mol % of the diacid units.

4. The furan diacid-based polyamide according to claim 1, wherein the furan diacid-based polyamide has a relative viscosity of 1.8-2.4.

5. The furan diacid-based polyamide according to claim 1, wherein the furan diacid-based polyamide has a melting point of 291-335° C.

6. The furan diacid-based polyamide according to claim 1, wherein the furan diacid-based polyamide has a water absorption rate of less than or equal to 3.3%.

7. A method for preparing the furan diacid-based polyamide according to claim 1, wherein the method comprises following steps:
adding reaction materials to a pressure reactor in proportion;
adding benzoic acid, sodium hypophosphite and deionized water, wherein an amount of benzoic acid is 2-3% of a total weight of diamine and diacid, an amount of sodium hypophosphite is 0.05-0.15% of a weight of other materials other than deionized water, and an amount of deionized water is 25-35% of a weight of the total materials;
performing vacuumizing and pumping high-purity nitrogen as a shielding gas into the pressure reactor, heating up to 210-230° C. within 2 h under stirring conditions, and mixing a reaction mixture for 0.5-2 h at 210-230° C.; and
heating reactants up to 220-240° C. under stirring conditions, proceeding with reaction for 1-3 h at a constant temperature of 220-240° C. and a constant pressure of 2.1-2.3 MPa, keeping the pressure constant by removing water formed, discharging a prepolymer after finishing the reaction, vacuum drying the prepolymer at 70-90° C. to obtain a prepolymerized product, and performing solid phase viscosification on the prepolymerized product for 8-12 h at 240-260° C. and a vacuum condition of 40-60 Pa, to obtain the furan diacid-based polyamide.

8. A furan diacid-based polyamide composition, wherein the composition comprises following components in parts by weight:
40-70 parts of the furan diacid-based polyamide according to claim 1;
10-30 parts of a halogen-free flame retardant; and
0-50 parts of a reinforcing material.

9. The furan diacid-based polyamide composition according to claim 8, wherein the halogen-free flame retardant is selected from at least one of the group consisting of a phosphine flame retardant, a hypophosphorous acid ester flame retardant, a hypophosphorous acid salt flame retardant, a phosphinate ester flame retardant, a phosphinate salt flame retardant, a phosphite ester flame retardant, a phosphite salt flame retardant, a phosphine oxide flame retardant, a hypophosphite ester flame retardant, a hypophosphite salt flame retardant, a phosphonate ester flame retardant, a phosphonate salt flame retardant, a phosphate ester flame retardant, a polyphosphate flame retardant, and a phosphinate salt flame retardant; the hypophosphite salt flame retardant is selected from at least one of the group consisting of aluminum hypophosphite and calcium hypophosphite; the phosphinate salt flame retardant is selected from at least one of the group consisting of aluminum dimethylphosphinate, aluminum diethylphosphinate, and aluminum methylethylphosphinate; the phosphate ester flame retardant is selected from at least one of the group consisting of bisphenol A bis(diphenyl phosphate), phenoxyphosphonitrile, resorcinol (diphenyl phosphate), triphenyl phosphate, melamine phosphate and melamine cyanurate; and the polyphosphate flame retardant is selected from at least one of the group consisting of ammonium polyphosphate, melamine polyphosphate, melamine pyrophosphate and melamine polyphosphate salt.

10. The furan diacid-based polyamide composition according to claim 8, wherein the reinforcing material is selected from at least one of the group consisting of a fibrous filler and a nonfibrous filler; the fibrous filler is selected from at least one of the group consisting of glass fiber, carbon fiber, basalt fiber, bamboo fiber, fibrilia, cellulosic fiber and aramid fiber; and the nonfibrous filler is selected from at least one of the group consisting of aluminium oxide, carbon black, clay, zirconium phosphate, kaolin, calcium carbonate, copper powder, kieselguhr, graphite, mica, silica, titanium dioxide, zeolite, talc, wollastonite, glass beads and glass powder.
